(19) United States
(12) Patent Application Publication
(10) Pub. No.: US 2023/0303368 A1
(43) Pub. Date: Sep. 28, 2023

(54) CAPSTAN DRIVE TRANSMISSION SELF-TENSIONING APPARATUS AND METHOD

(71) Applicant: Haply Robotics inc., Montreal (CA)

(72) Inventors: Felix DESOURDY, Montreal (CA); Dylan SAWATZKY, Montreal (CA); Antoine WEILL-DUFLOS, Montreal (CA)

(21) Appl. No.: 18/188,998

(22) Filed: Mar. 23, 2023

Related U.S. Application Data
(60) Provisional application No. 63/323,811, filed on Mar. 25, 2022.

(51) Int. Cl. B66D 1/20; B66D 1/74; B66D 1/12

(52) U.S. Cl. CPC B66D 1/20; B66D 1/7484; B66D 1/12

(57) ABSTRACT

Described are various embodiments of capstan drive transmission self-tensioning apparatus and method. In one embodiment, the capstan drive transmission self-tensioning apparatus comprises a body coupled to the capstan drive drum comprising a force providing member coupled to the cable and configured to displace the cable along a path increasing an effective distance between said first end and said second end of the cable thereby increasing a tension within said cable; a jamming assembly directly or indirectly coupled to said cable and configured to: allow motion of said cable along said path upon said tension being below a lower designated level; and prevent motion of said cable along an opposite path upon said tension being above an upper designated level. In some embodiments, the jamming assembly may comprise a spring-loaded rocker mechanism, a ratcheting mechanism or a directional frictional material to provide the jamming effect.

### CROSS-REFERENCE TO RELATED APPLICATIONS

This application claims the benefit of U.S. Provisional Application No. 63/323,811 filed Mar. 25, 2022, which is incorporated herein by reference in its entirety.

### FIELD OF THE DISCLOSURE

The present disclosure relates to capstan drive transmissions, and, in particular, to a capstan drive transmission self-tensioning apparatus and method.

### BACKGROUND

Some transmission mechanisms, like capstan drive transmissions, require a cable that maintains a quasi-constant tension. Traditionally, capstan drive transmissions feature two or more drums whose main axes are parallel and offset in a plane, connected by a single cable that winds around the exterior circumference of each drum, and is anchored on each end to interior points in one of the drums. Typically, both anchoring points have a fixed location, which maintains a constant length of cable between the two drums, transmitting the rotation of one drum to the other. However, friction, wear, creep, or elongation, may eventually stretch the cable, thereby introducing slack to the cable, removing the cable tension. Capstan drives are useful because they are backlash-free and backdriveable, but if the cable loses tension, slack is introduced into the cable, which can lead to a total failure of the transmission if the cable leaves the restraining grooves of the drum. Over time and repeated usage, cable materials tend to stretch and the cable loses tension. Most of the time, cables need to be reset or restrung to their initial tension periodically.

Existing solutions to the issue of cable stretch often use springs at cable anchoring points, but these tend to create a “soft feeling” as one end of the cable can pull at the spring, lowering the total tension compared to using a stiff anchoring point. Not using a spring as a cable anchoring point provides no method of automatic tensioning and the need to re-tension the cable often, as cables tend to stretch fairly quickly.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a capstan drive transmission tensioning apparatus and method that allows automatic tensioning of the capstan cable and prevents slack due to cable stretching while avoiding the softness provided by known spring-like mechanisms.

In accordance with a first aspect, there is provided a capstan drive transmission self-tensioning apparatus for automatically tensioning a stretched cable of a capstan drive transmission, a first end of said cable being affixed on a capstan drum at a first location; a second end of the cable being coupled to the tensioning apparatus, the tensioning apparatus comprising: a body coupled to the capstan drive drum, comprising; a force providing member coupled to the cable and configured to displace the cable along a path increasing an effective distance between said first end and said second end of the cable thereby increasing a tension within said cable; a jamming assembly directly or indirectly coupled to said cable and configured to: allow motion of said cable along said path upon said tension being below a lower designated level; prevent motion of said cable along an opposite path upon said tension being above an upper designated level.

In one embodiment, the body is the capstan drum.

In one embodiment, the jamming assembly comprises: a linear jamming channel defined within said body; a rocker member coupled to the force providing member and disposed so as to be moveable along the length of said linear jamming channel, the rocker member coupled to the cable so as to be rotatable between: a free configuration upon said tension in said cable being below said lower designated level, wherein said rocker member is movable along said jamming channel, thereby causing the rocker member to move along the length of said jamming channel due to said linear force, thereby pulling on the cable along said path and increasing said tension in said cable; and a jammed configuration upon said tension in said cable being above said upper designated level, wherein said rocker jammingly engages the jamming channel, thereby preventing rocker member from moving within the jamming channel.

In one embodiment, the jamming channel comprises a plurality of jamming structures along the length thereof, and wherein in said jammed configuration the rocker member engages said jamming structures.

In one embodiment, the jamming structures are ratchet teeth.

In one embodiment, the force providing member is a linear spring affixed at one end of the jamming channel.

In one embodiment, the force providing member is a first magnet affixed at one end of the jamming channel, and wherein said rocker member comprises a second magnet positioned with respect to said first magnet to receive a repulsive magnetic force therefrom.

In one embodiment, the second end of the cable is affixed directly on the rocker member.

In one embodiment, the second end of the cable is affixed at a second anchor location and wherein the cable is positioned to loop around the rocker member.

In one embodiment, the force providing member is a torsional spring coupled to a fixed canter pivot coupled to said body; and wherein said jamming assembly comprises: a pawl wheel rotatably coupled to the torsional spring to receive therefrom a first torque along said path, the pawl wheel comprising a plurality of pawl members extending outwardly from an outer circumference thereof, the pawl wheel having affixed thereto the second end of said cable, the cable proximate the second end thereof being oriented to provide a second torque to said pawl wheel along the opposite path via said tension, the pawl wheel further being, and configured to: a fixed outer ratchet wheel outwardly disposed around said pawl wheel and comprising a plurality of interior ratchet teeth extending from an inner circumference thereof, the plurality of pawl members and the ratchet teeth configured to: allow said pawl wheel to rotate along with the second end of the cable along said path upon said tension in the cable being below said lower designated level, thereby increasing said tension in said cable; and blockingly engage to prevent motion in the opposite path upon said tension in the cable being below said lower designated level.

In one embodiment, the cable engages a portion of an outer circumference of the fixed outer ratchet wheel and is redirected from the outer circumference to the pawl wheel in said orientation providing said second torque.

In one embodiment, the force providing member is a linear spring, the linear spring having affixed thereto said second end of the cable; and wherein said jamming assembly comprises: a fixed circular head member comprising a directional frictional material along a portion of the circumference thereof, and configured to receive in a sliding engagement along said portion said cable proximate said second end, the directional frictional material configured to have a smaller friction coefficient upon said cable slidingly moving along a first direction and a larger friction coefficient upon said cable slidingly moving along an opposite direction; wherein upon said tension in the cable being lower than said lower designated level, a net force of the force exerted by the linear spring and the tension in the cable causes the cable to slidingly move on said head portion in said first direction; and wherein upon said tension in the cable being larger than said upper designated level, said larger friction coefficient providing a frictional force selected to prevent motion of said cable in said opposite direction.

In one embodiment, the force providing member is a torsional spring affixed to said body; and wherein the jamming portion comprises: a worm screw mechanically coupled to said torsional spring so as to rotate along a length thereof under the effect of a spring force of said torsional spring; a gear comprising a plurality of gear teeth configured to engage said worm screw, the worm screw thereby providing a first torque on the gear along the first path, the gear coupled to said second end of the cable to provide a second torque to the gear along the opposite path under the action of said tension; wherein the apparatus is configured so that: upon said tension in the cable being lower than the lower designated level, a net torque on said gear resulting from said first torque and said second torque rotates the gear and the second end of the cable along said first path, thereby increasing said cable tension; and upon said tension in the cable being higher than the larger designated level, said worm screw preventing movement of the gear along the opposite path.

In one embodiment, the gear further comprises an elongated anchor member extending radially therefrom, the anchor member having affixed at a distal end thereof said second end of the cable, the cable proximate the second end being oriented substantially perpendicular to a length of the anchor member and positioned so as to provide the second torque to the gear along the opposite path under the action of said tension.

In accordance with a second aspect, there is provided method for automatically tightening a cable of a capstan drive transmission, a first end of said cable being affixed inside a capstan drum at a first location, the method comprising the steps of: coupling the cable to a force providing member configured to displace the cable along a path increasing an effective distance between said first end and a second end of the cable thereby increasing a tension within said cable; during operation of the capstan drive, allowing motion of said cable along said path upon said tension being below a lower designated level; and jamming the motion of said cable along an opposite path upon said tension being above an upper designated level.

In one embodiment, coupling the cable to the force providing member is done by: coupling the cable to a rocker member positioned and configured to be moveable along a linear jamming channel, the force providing member being affixed to an end of the jamming channel and providing a linear force to the rocker member along said jamming channel; wherein said allowing motion is done by: having the rocker member configured to be oriented so as to be movable along the jamming channel due to the linear force, thereby pulling on the cable along said path and increasing said tension in said cable; and wherein said jamming the motion is done by: having the rocker member configured to be rotated within the jamming channel via the cable tension to jammingly engage the jamming channel, thereby preventing rocker member from moving within the jamming channel.

In one embodiment, the force providing member is a torsional spring coupled to a fixed canter pivot, and wherein said coupling the cable to the force providing member is done by: coupling a pawl wheel to the torsional spring to receive therefrom a first torque along a first direction, and to the second end of the cable, the cable proximate the second end thereof being oriented to provide a second torque to said pawl wheel along a second direction via said tension, wherein said allowing motion is done by: having the pawl wheel fittingly engaged within a fixed ratchet ring comprising a plurality of ratchet teeth along an inner circumference thereof, the plurality of pawls and the ratchet teeth being configured to allow the pawl wheel to rotate along said first direction to move said second end of the cable along said path thereby increasing said tension in said cable; and wherein said jamming the motion is done by: having the plurality of pawls and the ratchet teeth configured to prevent motion of the pawl wheel in the second direction.

In one embodiment, the force providing member is a linear spring; and wherein said coupling the cable to the force providing member is done by: coupling the second end of the cable to the linear spring, the cable proximate the second end thereof being slidingly engaged on a portion of a circumference of a fixed circular head portion comprising a directional frictional material thereon, the directional frictional material configured to have a smaller friction coefficient upon said cable slidingly moving along said first path and a larger friction coefficient upon said cable slidingly moving along said opposite path; and wherein said allowing the motion is done by: wherein upon said tension in the cable being lower than said lower designated level, a net force of the force exerted by the linear spring and the tension in the cable causes the cable to slidingly move on said head portion along said first path; and wherein said preventing the opposite motion wherein upon said tension in the cable being larger than said upper designated level, said larger friction coefficient providing a frictional force selected to prevent motion of said cable in said opposite path.

In one embodiment, the force providing member is a torsional spring; and wherein said coupling the cable to the force providing member is done by: coupling the second end of the cable to a gear comprising a plurality of gear teeth configured to engage a worm screw, the worm screw coupled to said torsional spring so as to rotate along a length thereof under the effect of a spring force of said torsional spring, the worm screw thereby providing a first torque on the gear along the first path, the cable oriented to provide a second torque to the gear along the opposite path under the action of said cable tension; wherein said allowing the motion is done by: upon said tension in the cable being lower than the lower designated level, a net torque on said gear resulting from said first torque and said second torque rotates the gear, and said anchor member, along said first direction, moving said second end of the cable along said path thereby increasing said tension; and wherein said preventing the opposite motion is done by: upon said tension in the cable being higher than the larger designated level, said worm screw preventing movement of the gear and the cable second end of the cable along the opposite path.

In accordance with a third aspect, there is provided a self-tensioning capstan drum for transmitting rotational motion from a motor shaft to a second shaft, the motor shaft having a cable wounded thereon, the drum comprising: a body having a substantial circular profile, comprising an aperture at the center thereof configured to rotatably couple the body to the second shaft, the body further comprising one or more engagement structures along an outer circumference thereof having the cable engaged thereon to transfer rotational motion from the motor shaft thereto; a first anchoring portion configured to receive a fastener for fastening a first end of said cable at a first location on said body; a second anchoring portion configured to receive a fastener for fastening a second end of said cable at a second location on said body; a linear channel defined within said body; a force providing member configured to provide a linear force along the linear channel; a rocker positioned and configured to be movable along said linear channel, the rocker coupled to the force providing member to receive said linear force therefrom and further coupled to the cable proximate to the second end thereof so as to displace the cable and receive therefrom a tilting force due to a cable tension; and wherein upon said tilting force being below a lower designated level, the rocker being oriented so as to be displaced along the linear channel due to said linear force, thereby increasing said cable tension; and upon said tilting force increasing above a designated level due to said increasing cable tension, the tilting force rotating the rocker to jammingly engage the linear channel and prevent said linear force from further increasing said cable tension.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1A-1D are schematic diagrams illustrating a capstan drive transmission comprising a tensioning apparatus with a jamming rocker mechanism, in accordance with one embodiment.

FIG. 2A and FIG. 2B are schematic diagrams illustrating the tensioning apparatus of FIG. 1C and FIG. 1D, respectively, further comprising ratchet teeth, in accordance with one embodiment.

FIG. 3 is a schematic diagram illustrating a cable being looped around a rocker, in accordance with one embodiment.

FIG. 4 is a schematic diagram illustrating a magnet providing a repulsive magnetic force to the rocker, in accordance with one embodiment.

FIG. 5 is a schematic diagram illustrating a capstan drive transmission tensioning apparatus comprising a worm screw mechanism, in accordance with one embodiment.

FIG. 6 is a schematic diagram illustrating a capstan drive transmission tensioning apparatus comprising a ratchet mechanism using pawls, in accordance with one embodiment.

FIG. 7 is a schematic diagram illustrating a capstan drive transmission tensioning apparatus comprising a directional frictional material, in accordance with one embodiment.

FIGS. 8A-8D are a perspective view, a front view and two cross-sectional views of a capstan drum comprising a self-tensioning mechanism, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

In accordance with different embodiments, a capstan drive transmission tensioning apparatus and method is disclosed, which allows automatic tensioning of the capstan cable without user intervention when the cable stretches, preventing transmission failure and extending the longevity of the capstan drive transmission while avoiding the “softness” usually present with spring cable anchors. Advantageously, the tensioning apparatus and method disclosed herein, combines the use of a spring member mechanically coupled proximate the end of the capstan cable to drive a tightening motion increasing tension and a blocking or locking portion that is configured to allow the tightening motion of the cable upon the tension being lower than a lower designated level but to prevent or block motion of the cable in the opposite direction upon the tension being higher than an upper designated level (e.g., the desired tension). The use of the blocking portion avoids the “softness” of solutions relying only on a spring. In some embodiments, the blocking portion of the apparatus may be provided by a ratcheting mechanism, but other embodiments may rely on other mechanisms as well, as will be made clear below.

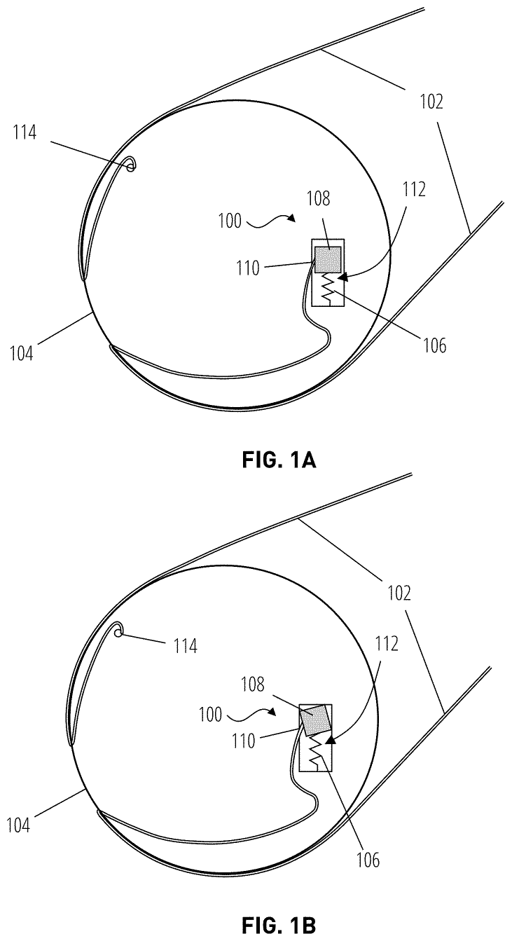

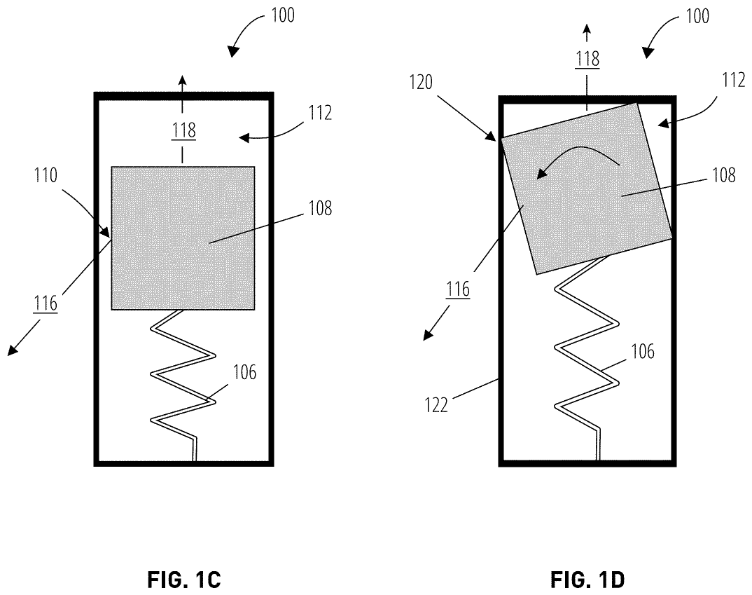

FIGS. 1A-1D show a capstan drive transmission tensioning apparatus mounted or affixed within a capstan drum, in accordance with one embodiment. In this exemplary embodiment, the capstan tensioning apparatus 100 presented here can automatically tension itself through the use of one fixed anchor and one jamming rocker mechanism mounted on a spring.

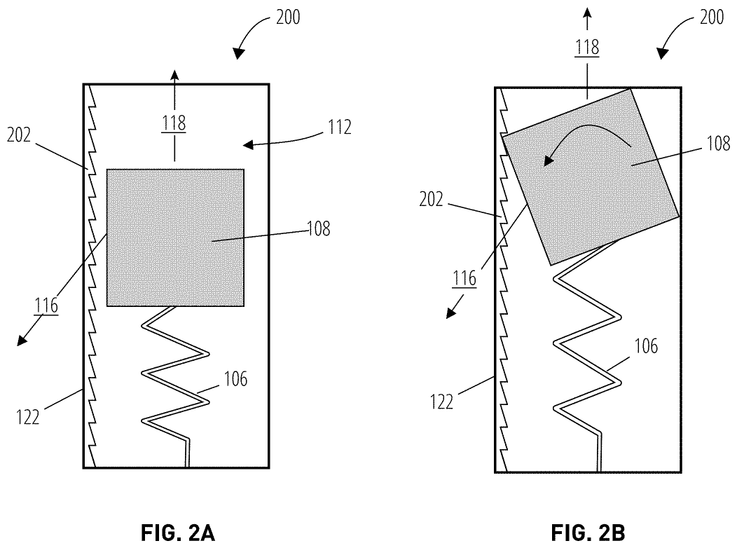

In the exemplary embodiments of FIG. 1A and FIG. 1B, the cable 102 is shown encircling the exterior circumference of the capstan drum 104, and is tensioned by means of a spring-loaded jamming mechanism, which automatically adjusts when the cable 102 stretches via the action of a spring 106. The cable 102 is fixed to a lateral side of the rocker 108 (e.g., cable anchor 110), and the rocker 108 can translate linearly along the jamming-capable channel 112, one non-limiting example of which is a jamming mechanism illustrated in FIG. 1C and FIG. 1D, or another one using a continuous (linear) ratchet mechanism as illustrated in FIG. 2A and FIG. 2B. When the cable 102 stretches over the course of normal use, slack is introduced into the cable 102, which lowers the tension of the cable 102 at the anchor point 110, which imbalances the forces acting on the rocker 108, which is located within the jamming channel 112. By decreasing the cable tension, the rocker 108 is no longer in equilibrium, and the rocker 108 translates along the jamming channel 112 in the direction of the spring force. As the rocker 108 translates, the effective distance between the anchor points increases, causing the cable slack to decrease to zero. As the cable 102 loses slack, the rocker 108 experiences the cable tension from the cable attachment point 110 on the side of the rocker 108, creating an unbalanced force that causes the rocker 108 to rotate or jam within the channel 112. When the rocker mechanism is jammed within the channel 112, it acts as a fixed anchor point for the cable 102, and during normal use of the capstan drive (i.e. using a haptic device, hitting a virtual wall, etc.), no give or slack in the cable occurs. When the cable 102 begins to stretch, removing the cable tension and allowing the rocker to translate further along the channel 112 and jam again once the tension is reintroduced.

FIG. 1B shows the jamming action of the tensioning apparatus 100. When slack is introduced to the cable 102 by means of cable stretch, the spring force of spring 106 would then push the rocker mechanism 108 along the channel 112 until the cable slack disappears, tensioning the cable. The cable tension, applied on the side of the rocker 108, would create a moment about the rocker's central pivot point, unbalancing the rocker 108 such that it jams within the channel 112. When jammed, the tensioning apparatus does not “feel soft” due to spring extension at the anchor points, but instead acts as a fixed anchor point 114, preventing give, or looseness, in the cable.

FIG. 1C shows a force diagram of a rocker mechanism within the tensioning apparatus 100. In this example, the cable's slack prevents the cable 102, which is anchored or affixed to a lateral side of the rocker 108 (e.g., at an anchor point 110), from pulling on the rocker 108, which means that the cable tension 116 is zero. The spring force 118 of the spring 106 mounted underneath the rocker mechanism pushes the rocker 108 along the channel 112 unimpeded, at least until the slack in the cable disappears.

The skilled person in the art will understand that the rocker 108 is not limited to having a square or rectangular profile, such as the one illustrated herein, and that other shapes may be considered as well, as long as it provide a sufficient jamming action upon the rocker engaging or abutting against one or more sides or inner surfaces of the jamming channel.

FIG. 1D shows the force diagram of the apparatus 100 that is jammed within the channel 112. When the rocker mechanism translates along the channel 112 due to slack in the cable, it eventually translates far enough such that the cable becomes fully tensioned, and thus experiences the cable tension 116 on a side of the rocker 108 offset from the line of action of the spring 106. This imbalance in forces causes the rocker 108 to rotate, tilt or jam, such that it locks in place within the channel (e.g., in this example by frictionally abutting at a location 120 against an inner surface 122 of the channel 112), creating a fixed anchor for the cable endpoint.

In some embodiments, the jamming channel 112 may take the form of a tunnel or elongated aperture. Other embodiments may have part of the channel open and accessible along its length, as long as it provides the means to guide the rocker along its path.

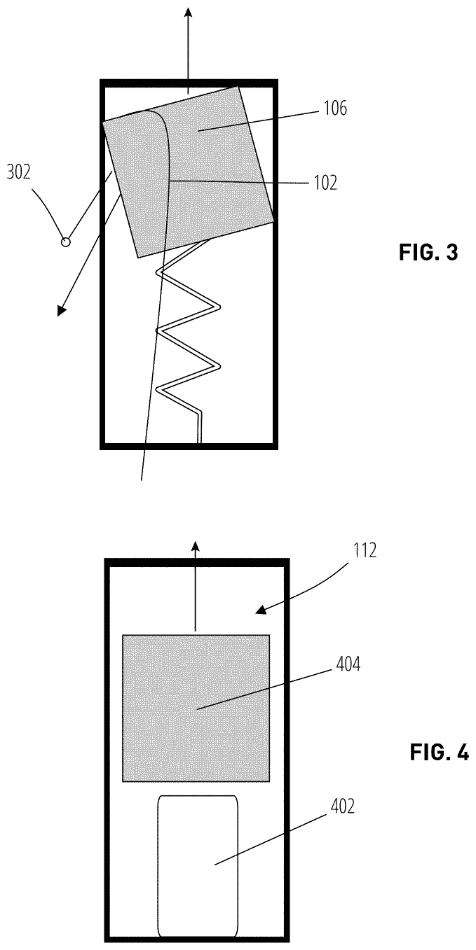

The skilled person in the art will appreciate that the cable 102 doesn't necessarily have to be directly affixed or attached to the rocker 108. In some embodiments, for example as illustrated in FIG. 3, the second end of the cable can be affixed or attached to an anchor point 302 located at another location and have portion of the cable 102 proximate that second end looped around rocker 108 so as to provide the required force 116 in the required orientation for rotating or tilting the rocker 108 upon the tension being sufficiently increased. In some embodiments, the shape of the rocker 108 may be configured so as provide additional restraining structures that restrain the cable from slipping of while the cable is in tension.

Similarly, the means for providing the upwardly oriented force along the channel may not be limited to a spring force. The skilled person in the art will understand that any means to provide a force that varies as a function of displacement of the rocker along the channel length may be used, without limitation. This may include using other resilient materials in different configurations. As a non-limiting examples, FIG. 4 illustrates schematically an embodiment using magnets 402 and 404 having poles aligned to provide a repulsive magnetic force therebetween. Magnet 402 is affixed while moveable magnet 404 acts as the rocker, the repulsive force on the magnet 404 providing the required force along the channel length.

FIG. 2A and FIG. 2B show another force diagram of a rocker mechanism within a tensioning apparatus 200. This example is similar to the one illustrated in FIGS. 1C and 1D, but the channel 112 further comprises along the inner surface 122 thereof a plurality of jamming structures, namely in this example a plurality of ratchet teeth 202. These are positioned so as to be blockingly engaged by the rocker 108 upon the rocker 108 being rotated or tilted as shown in FIG. 2B, thereby offering an improved jamming. The jamming structures are not limited to ratchet teeth but may also take the form of grooves, depressions or the like.

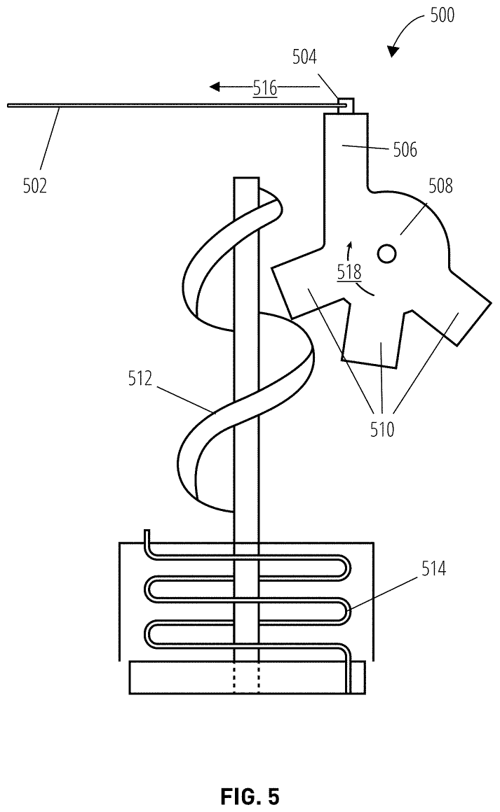

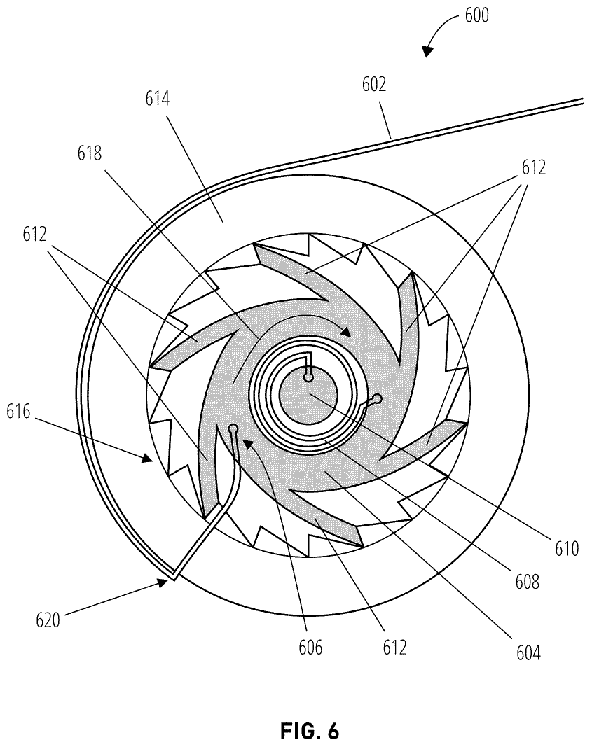

FIG. 5 shows another example of a capstan drive transmission tensioning apparatus 500 that uses a worm screw mechanism preloaded by a torsional spring, in accordance with one embodiment. In this exemplary embodiment, the capstan cable 502 is affixed or anchored on a cable anchor 504 located at the end of elongated anchor member 506 extending away radially from a rotatably mounted gear 508. The gear itself comprises a plurality of gear teeth 510 and is configured to engage and be driven by a worm screw 512, itself rotatably coupled to and driven by a preloaded torsional spring 514. The capstan cable 502, when in tension, exerts a force 516 in the counterclockwise direction of the gear 508, effectively jamming the gear 508 on the worm screw 512 so that the cable 502 is fixed in place by the cable anchor 504. Indeed, the backdriving force of the gear 508 on the worm screw 512 is not oriented so as to provide sufficient torque to the worm screw 512, and thus this configuration effectively jams backward motion.

When the cable 502 stretches, slack is introduced in the cable 502, which allows the gear 508 to rotate clockwise (arrow 518) because of the motion of the worm screw 512 actuated by a torsional spring 514. The clockwise rotation 518 of the gear 508 will translate the cable anchor 504, extending the effective distance between the cable anchors until the cable is in tension again, and thus jams on the worm gear.

FIG. 6 shows a capstan drive transmission tensioning apparatus 600 that uses a ratchet mechanism preloaded by a torsional spring, in accordance with one embodiment. In this example, the capstan cable 602 is affixed or anchored on a pawl wheel 604 at an anchor point 606. The pawl wheel is further rotatably coupled to the preloaded torsional spring 608, itself coupled to a axle member or pivot 610. When functioning properly, the cable 602 is disposed so as to exert a force on the pawl wheel 604 that counteracts the force provided by the torsional spring 608. The pawl wheel 604 comprises a plurality of pawl members 612 extending outwardly of an outer circumference thereof. In this example, the pawl members 612 are spread evenly but other arrangements may also be used. The pawl members 612 may be resiliently supported by a spring-leaf mechanism, or be made from a substantially resilient material, or use other mechanisms known in the art. The pawl wheel 604 is further disposed within a fixed ratchet ring 614 comprising a plurality of ratchet teeth 616 extending from an inner circumference thereof. In some embodiments, the fixed ratchet ring 614 and the axle member 610 may be affixed or coupled to a body or casing located or attached within the capstan drum. The pawl members 612 and the plurality of ratchet teeth 616 are configured so as to, during engagement, allow motion of the pawl wheel 604 in the clockwise direction, while preventing motion in the counterclockwise direction. When the cable 602 stretches, slack is introduced in the cable 602, thus lowering tension which unbalances the forces on the pawl wheel 604. The pawl wheel 604 is rotated in the clockwise direction 618. As the pawl wheel 604 rotates within the ratchet ring 614, the cable anchor member 606 rotates as well, increasing the tension in the cable 602 as the effective distance between the cable anchors increases. When the cable 602 is tensioned (e.g., above an upper designated level), the pawl wheel 604 is prevented from rotating counterclockwise by means of the ratchet mechanism, which keeps the cable anchor 606 fixed such that cable anchor 606 translation can only occur in one direction, the direction of cable stretching.

To provide the required cable orientation, in some embodiments, the cable 602 may be configured to encircle an outer circumference of the ratchet ring 614, and comprise an aperture 620 (or a restraining means or other similar structure) configured to be engageable by the cable 602 so as to re-orient the cable in the proper direction towards the cable anchor 606 of the pawl wheel 604, such that increased tension in the cable provides a force or torque oriented counterclockwise on the pawl wheel 604.

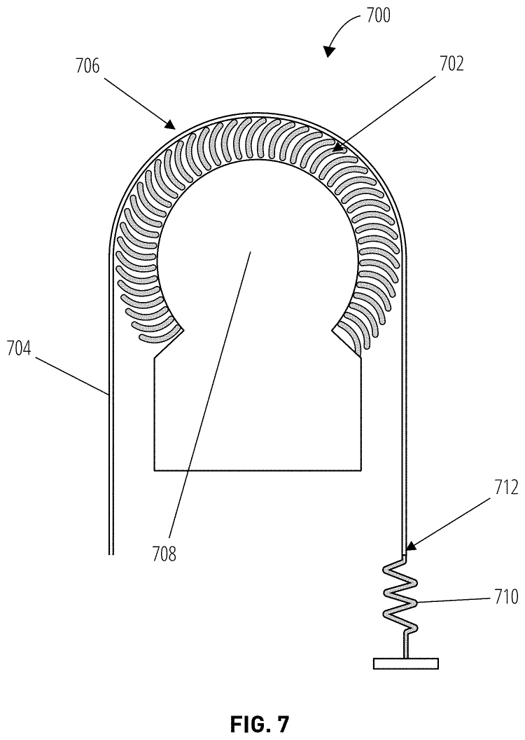

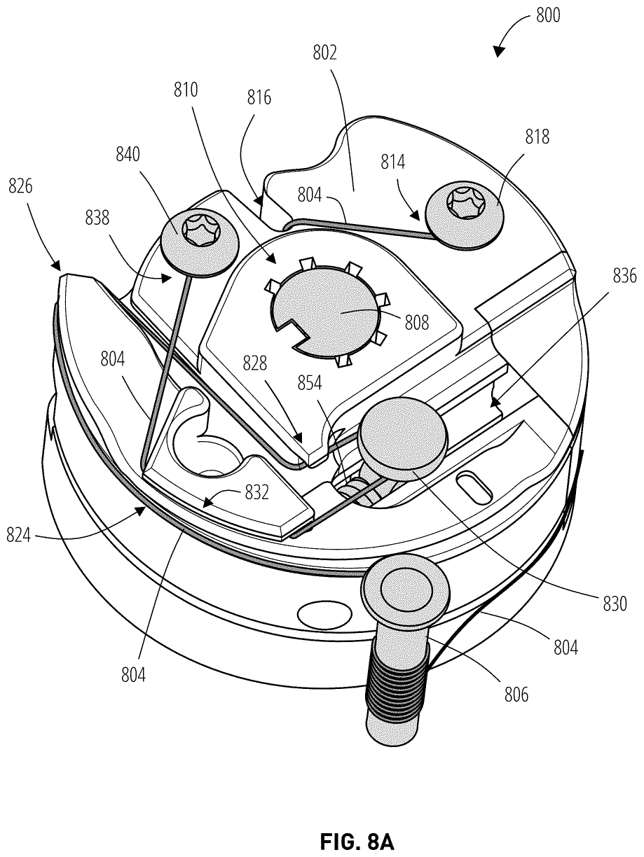

FIG. 7 shows a capstan tensioning apparatus 700 that uses a directional frictional material to tension the cable, in accordance with one embodiment. In this exemplary embodiment, the frictional material 702 is configured to allow translational motion in one direction (shown here as clockwise as an example only), while its microstructure or macrostructure prevents motion in another direction, shown here as counterclockwise (e.g., having a substantially larger friction coefficient along that direction than the opposite direction). One example of such a material is a cat's tongue, which features barbed spines that introduce friction only in certain directions, however, other materials having such properties known in the art may also be used without limitation.

In FIG. 7, the capstan cable 704 is shown being positioned so as to slidingly engage a portion 706 of the outer circumference of a rounded head member 708 comprising the material 702 thereon. The end of cable 704 is affixed or anchored on a linear spring 710 at an anchoring location 712. As the cable 704 stretches, the spring 710 on the opposite side of the head 708 of the frictional material 702 pulls the cable clockwise around the frictional material head 708. As the cable 704 is pulled by the spring 710, tension is reintroduced to the cable 704, and it is prevented from sliding counterclockwise by means of the directional frictional material 702. The directional frictional material 702 allows the apparatus 700 to adapt to cable stretching by tensioning the cable 704 and avoids the “softness” of spring cable anchors by using a fixed anchor analog, in this case, the frictional material head 708. The head 708 and the spring 710 may be, in accordance with different embodiments that will be understood by the skilled person in the art, affixed or coupled to a body, frame or casing mounted or affixed inside the capstan drum.

In some embodiments, the cable 704 itself or a portion thereof (for example along the head 708) may be configured to provide directional friction (e.g., larger friction when sliding along one direction than in the opposite direction). In some embodiments, both the head 708 and the cable 704 may have such properties and be configured to act in combination.

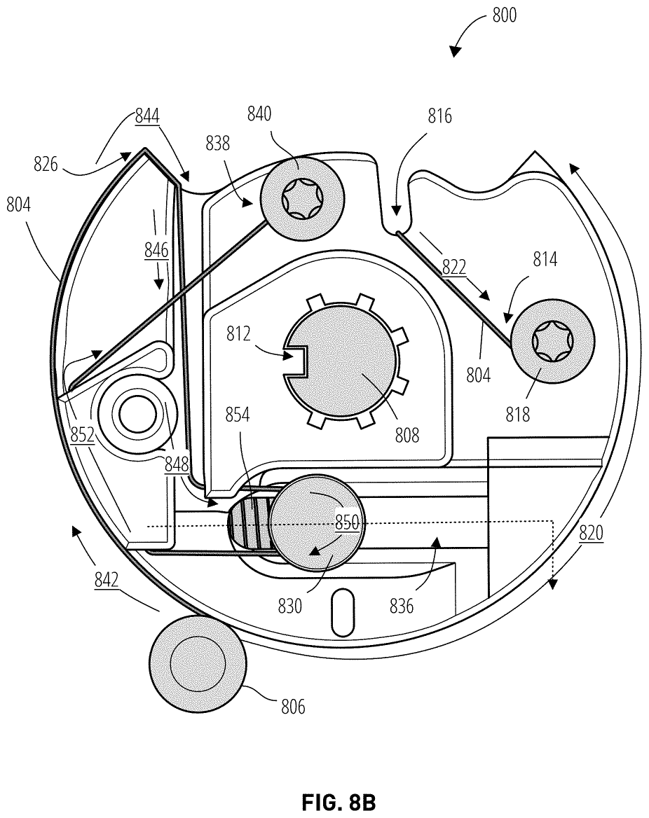

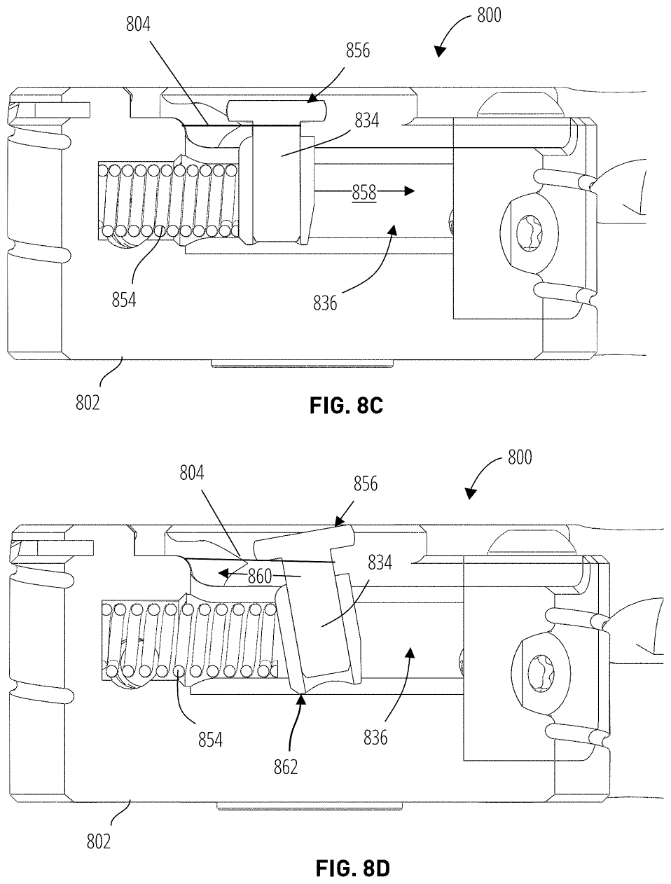

FIGS. 8A-8D show a capstan drum 800 comprising a self-tensioning mechanism, in accordance with one embodiment. In this example, the self-tensioning mechanism is integrated directly into a same drum body 802. The drum body 802 has a substantially circular cross-sectional profile and comprises a plurality of grooves or channels to guide the cable 804 in the illustrated configuration. The cable 804 is wound around a motor shaft 806 and coupled to the drum body 802 to transfer the rotational driving motion thereto, which in turn drives a shaft 808 lockingly engaged in the centrally located apertures 810 of the drum via an engagement member 812. A first end 814 of the cable 804 is extended (on the right side in FIG. 8A) from the bottom of the motor shaft 806 to engage the circumference of the body 802, loops within the groove 816 and be tightly fastened at a first anchoring location (e.g., via fastener 818). The trajectory of this portion of the cable 804 is shown by following the arrows 820 and 822, respectively, in FIG. 8B. The other portion of the cable 804 engages, from the top of the motor shaft 806, a groove 824 along a portion 824 of the outer circumference of the body 802, loops around the corners 826 and 828, to engage the rocker 830 by looping around it to engage a channel or groove 832. This arrangement allows cable portions extending on each side from the rocker 834 to be both substantially parallel to the length of the jamming channel 836. The second end 838 of the cable 804 is then tightly fastened to a second anchoring location (e.g., via fastener 840). This second trajectory may be followed via the arrows 842, 844, 846, 848, 850, and 852. During installation, the cable 804 is tightened to provide the desired tension necessary to operate the capstan drive. However, during prolonged use, slack is introduced in the cable and the spring-loaded rocker 834 mechanism is designed to automatically re-tension the cable.

FIG. 8C and FIG. 8D are cross-sectional views of the capstan drum 800 indicated by the dotted line in FIG. 8B. FIG. 8C shows a side view of the rocker 834, linear spring 854 and jamming channel 836. The side profile of the rocker 834 is T-shaped and comprises a wider head portion 856 configured to stop the cable 804 from slipping off the rocker 834 under tension. Typically the cable 804 is configured to rest close to the head portion 856 to provide the torque necessary to rotate the rocker 834 between a free configuration and a jammed configuration.

When the tension in the cable 804 is reduced, due to stretching after prolonged use, the rocker 834 takes the free configuration shown in FIG. 8C and engages further along the jamming channel 836 via the force 858 from the linear spring 854, which pulls on the cable 804 and increases tension again.

Upon the tension in the cable 804 being increased above an upper designated level, the force 860 due to the cable tension rotates or tilts the rocker 834 in the jammed configuration illustrated in FIG. 8D. In this configuration, the rocker is rotated so that the head portion 856 leans towards the linear spring 854, which makes the now misaligned rocker 834 jam inside the channel 836 which prevents the spring for moving the cable 804 (for example by having a portion 862 frictionally abutting against the inner surface of the jamming channel 836). The shape of the rocker 834 and of the channel may be configured to have multiple such portions of the rocker 830 engaging the side of the jamming channel 836 at different locations, to provide increased jamming.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A capstan drive transmission self-tensioning apparatus for automatically tensioning a stretched cable of a capstan drive transmission, a first end of said cable being affixed on a capstan drum at a first location; a second end of the cable being coupled to the tensioning apparatus, the tensioning apparatus comprising:
a housing coupled to the capstan drive drum, comprising;
a force providing member coupled to the cable and configured to displace the cable along a path increasing an effective distance between said first end and said second end of the cable thereby increasing a tension within said cable;
a jamming assembly directly or indirectly coupled to said cable and configured to:
allow motion of said cable along said path upon said tension being below a lower designated level;
prevent motion of said cable along an opposite path upon said tension being above an upper designated level.

2. The capstan drive transmission self-tensioning apparatus of claim 1, wherein said housing forms the capstan drum.

3. The capstan drive transmission self-tensioning apparatus of claim 1, wherein said jamming assembly comprises:
a linear jamming channel defined within said body;
a rocker member coupled to the force providing member and disposed so as to be moveable along the length of said linear jamming channel, the rocker member coupled to the cable so as to be rotatable between:
a free configuration upon said tension in said cable being below said lower designated level, wherein said rocker member is movable along said jamming channel, thereby causing the rocker member to move along the length of said jamming channel due to said linear force, thereby pulling on the cable along said path and increasing said tension in said cable; and
a jammed configuration upon said tension in said cable being above said upper designated level, wherein said rocker jammingly engages the jamming channel, thereby preventing rocker member from moving within the jamming channel.

4. The capstan drive transmission self-tensioning apparatus of claim 3, wherein said jamming channel comprises a plurality of jamming structures along the length thereof, and wherein in said jammed configuration the rocker member engages said jamming structures.

5. The capstan drive transmission self-tensioning apparatus of claim 4, wherein said jamming structures are ratchet teeth.

6. The capstan drive transmission self-tensioning apparatus of claim 3, wherein said force providing member is a linear spring affixed at one end of the jamming channel.

7. The capstan drive transmission self-tensioning apparatus of claim 3, wherein said force providing member is a first magnet affixed at one end of the jamming channel, and wherein said rocker member comprises a second magnet positioned with respect to said first magnet to receive a repulsive magnetic force therefrom.

8. The capstan drive transmission self-tensioning apparatus of claim 3, wherein the second end of the cable is affixed directly on the rocker member.

9. The capstan drive transmission self-tensioning apparatus of claim 3, wherein the second end of the cable is affixed at a second anchor location and wherein the cable is positioned to loop around the rocker member.

10. The capstan drive transmission self-tensioning apparatus of claim 1, wherein said force providing member is a torsional spring coupled to a fixed canter pivot coupled to said body; and
wherein said jamming assembly comprises:
a pawl wheel rotatably coupled to the torsional spring to receive therefrom a first torque along said path, the pawl wheel comprising a plurality of pawl members extending outwardly from an outer circumference thereof, the pawl wheel having affixed thereto the second end of said cable, the cable proximate the second end thereof being oriented to provide a second torque to said pawl wheel along the opposite path via said tension, the pawl wheel further being, and configured to:
a fixed outer ratchet wheel outwardly disposed around said pawl wheel and comprising a plurality of interior ratchet teeth extending from an inner circumference thereof, the plurality of pawl members and the ratchet teeth configured to:
allow said pawl wheel to rotate along with the second end of the cable along said path upon said tension in the cable being below said lower designated level, thereby increasing said tension in said cable; and
blockingly engage to prevent motion in the opposite path upon said tension in the cable being below said lower designated level.

11. The capstan drive transmission self-tensioning apparatus of claim 10, wherein the cable engages a portion of an outer circumference of the fixed outer ratchet wheel and is redirected from the outer circumference to the pawl wheel in said orientation providing said second torque.

12. The capstan drive transmission self-tensioning apparatus of claim 1, wherein said force providing member is a linear spring, the linear spring having affixed thereto said second end of the cable; and
wherein said jamming assembly comprises:
a fixed circular head member comprising a directional frictional material along a portion of the circumference thereof, and configured to receive in a sliding engagement along said portion said cable proximate said second end, the directional frictional material configured to have a smaller friction coefficient upon said cable slidingly moving along a first direction and a larger friction coefficient upon said cable slidingly moving along an opposite direction;
wherein upon said tension in the cable being lower than said lower designated level, a net force of the force exerted by the linear spring and the tension in the cable causes the cable to slidingly move on said head portion in said first direction; and
wherein upon said tension in the cable being larger than said upper designated level, said larger friction coefficient providing a frictional force selected to prevent motion of said cable in said opposite direction.

13. The capstan drive transmission self-tensioning apparatus of claim 1, wherein said force providing member is a torsional spring affixed to said body; and
wherein the jamming portion comprises:
a worm screw mechanically coupled to said torsional spring so as to rotate along a length thereof under the effect of a spring force of said torsional spring;
a gear comprising a plurality of gear teeth configured to engage said worm screw, the worm screw thereby providing a first torque on the gear along the first path, the gear coupled to said second end of the cable to provide a second torque to the gear along the opposite path under the action of said tension;
wherein the apparatus is configured so that:
upon said tension in the cable being lower than the lower designated level, a net torque on said gear resulting from said first torque and said second torque rotates the gear and the second end of the cable along said first path, thereby increasing said cable tension; and
upon said tension in the cable being higher than the larger designated level, said worm screw preventing movement of the gear along the opposite path.

14. The capstan drive transmission self-tensioning apparatus of claim 13, wherein the gear further comprises an elongated anchor member extending radially therefrom, the anchor member having affixed at a distal end thereof said second end of the cable, the cable proximate the second end being oriented substantially perpendicular to a length of the anchor member and positioned so as to provide the second torque to the gear along the opposite path under the action of said tension.

15. A method for automatically tensioning a cable of a capstan drive transmission, a first end of said cable being affixed inside a capstan drum at a first location, the method comprising the steps of:
coupling the cable to a force providing member configured to displace the cable along a path increasing an effective distance between said first end and a second end of the cable thereby increasing a tension within said cable;
during operation of the capstan drive, allowing motion of said cable along said path upon said tension being below a lower designated level; and
jamming the motion of said cable along an opposite path upon said tension being above an upper designated level.

16. The method of claim 15, wherein said coupling the cable to the force providing member is done by:
coupling the cable to a rocker member positioned and configured to be moveable along a linear jamming channel, the force providing member being affixed to an end of the jamming channel and providing a linear force to the rocker member along said jamming channel;
wherein said allowing motion is done by:
having the rocker member configured to be oriented so as to be movable along the jamming channel due to the linear force, thereby pulling on the cable along said path and increasing said tension in said cable; and
wherein said jamming the motion is done by:
having the rocker member configured to be rotated within the jamming channel via the cable tension to jammingly engage the jamming channel, thereby preventing rocker member from moving within the jamming channel.

17. The method of claim 15, wherein the force providing member is a torsional spring coupled to a fixed canter pivot, and
wherein said coupling the cable to the force providing member is done by:
coupling a pawl wheel to the torsional spring to receive therefrom a first torque along a first direction, and to a second end of the cable, the cable proximate the second end thereof being oriented to provide a second torque to said pawl wheel along a second direction via said tension,
wherein said allowing motion is done by:
having the pawl wheel fittingly engaged within a fixed ratchet ring comprising a plurality of ratchet teeth along an inner circumference thereof, the plurality of pawls and the ratchet teeth being configured to allow the pawl wheel to rotate along said first direction to move said second end of the cable along said path thereby increasing said tension in said cable; and
wherein said jamming the motion is done by:
having the plurality of pawls and the ratchet teeth configured to prevent motion of the pawl wheel in the second direction.

18. The method of claim 15, wherein said force providing member is a linear spring; and
wherein said coupling the cable to the force providing member is done by:
coupling the second end of the cable to the linear spring, the cable proximate the second end thereof being slidingly engaged on a portion of a circumference of a fixed circular head portion comprising a directional frictional material thereon, the directional frictional material configured to have a smaller friction coefficient upon said cable slidingly moving along said first path and a larger friction coefficient upon said cable slidingly moving along said opposite path; and
wherein said allowing the motion is done by:
wherein upon said tension in the cable being lower than said lower designated level, a net force of the force exerted by the linear spring and the tension in the cable causes the cable to slidingly move on said head portion along said first path; and
wherein said preventing the opposite motion
wherein upon said tension in the cable being larger than said upper designated level, said larger friction coefficient providing a frictional force selected to pre vent motion of said cable in said opposite path.

19. The method of claim 15, said force providing member is a torsional spring; and
wherein said coupling the cable to the force providing member is done by:
coupling the second end of the cable to a gear comprising a plurality of gear teeth configured to engage a worm screw, the worm screw coupled to said torsional spring so as to rotate along a length thereof under the effect of a spring force of said torsional spring, the worm screw thereby providing a first torque on the gear along the first path, the cable oriented to provide a second torque to the gear along the opposite path under the action of said cable tension;
wherein said allowing the motion is done by:
upon said tension in the cable being lower than the lower designated level, a net torque on said gear resulting from said first torque and said second torque rotates the gear, and said anchor member, along said first direction, moving said second end of the cable along said path thereby increasing said tension; and
wherein said preventing the opposite motion is done by:
upon said tension in the cable being higher than the larger designated level, said worm screw preventing movement of the gear and the cable second end of the cable along the opposite path.

20. A self-tensioning capstan drum for transmitting rotational motion from a motor, a shaft of the motor having a cable wounded thereto, the drum comprising:
a body having a substantial circular profile, comprising an aperture at the center thereof configured to rotatably couple the body to an axis, the body further comprising one or more engagement structures along an outer circumference thereof having the cable engaged thereon to transfer rotational motion from the motor shaft thereto;
a first anchoring portion configured to receive a fastener for fastening a first end of said cable at a first location on said body;
a second anchoring portion configured to receive a fastener for fastening a second end of said cable at a second location on said body;
a linear channel defined within said body;
a force providing member configured to provide a linear force along the linear channel;
a rocker positioned and configured to be movable along said linear channel, the rocker coupled to the force providing member to receive said linear force therefrom and further coupled to the cable proximate to the second end thereof so as to displace the cable and receive therefrom a tilting force due to a cable tension; and
wherein upon said tilting force being below a lower designated level, the rocker being oriented so as to be displaced along the linear channel due to said linear force, thereby increasing said cable tension; and
upon said tilting force increasing above a designated level due to said increasing cable tension, the tilting force rotating the rocker to jammingly engage the linear channel and prevent said linear force from further increasing said cable tension.
